(19) United States
(12) Patent Application Publication
(10) Pub. No.: US 2009/0178500 A1
(43) Pub. Date: Jul. 16, 2009

(54) Transmission system for a vehicle

(75) Inventor: Bernhard Walter, Oberkirch-Haslach (DE)

Correspondence Address: ALFRED J MANGELS, 4729 CORNELL ROAD, CINCINNATI, OH, 452412433, US

(73) Assignee: LUK Lamellen und Kupplungsbau Beteiligungs KG, Buhl (DE)

(21) Appl. No.: 12/317,245

(22) Filed: Dec. 20, 2008

Related U.S. Application Data
(60) Provisional application No. 61/008,705, filed on Dec. 21, 2007.

(51) Int. Cl. F02N 15/06

(52) U.S. Cl. 74/6

(57) ABSTRACT

A transmission system for a vehicle is proposed, which is coupled through a start-up element to a drive engine, an adjustable crank mechanism being provided as the start-up element and an input shaft of the crank mechanism being coupled on the drive side with a drive shaft of the drive engine.

### BACKGROUND OF THE INVENTION

1. Field of the Invention

The present invention relates to a transmission system for a vehicle, which is coupled to a drive engine through a start-up element.

2. Description of the Related Art

Transmission assemblies for vehicles are known from automotive engineering. In the known transmission systems, clutches are used for example, in particular with drives having a combustion engine, to reduce the speed differential during the start-up process when engaging the clutch. As that happens, much energy is converted to frictional heat, so that it is necessary to cool the clutch adequately. Furthermore, special designs are necessary to carry out this process comfortably and without excess wear to components.

Furthermore, a transmission is known from published patent DE 102 43 535 A1 which uses an adjustable crank mechanism to set various transmission ratios. The crank mechanism includes a driving shaft and a driven shaft, which are situated rotatably and parallel to each other in the transmission case. The two shafts are connected to each other in a drive relationship. This connection is accomplished by an eccentric drive provided on the driving shaft and a free-wheel device provided on the driven shaft, which are connected with each other through a plurality of connecting elements in the form of connecting rods. The eccentric drive is realized by a plurality of eccentric units. To form an eccentric unit, the driving shaft has, situated eccentrically opposite the axis of rotation of this driving shaft, a guide area on whose circumferential surface an eccentric component is rotatably supported. The driven shaft, or the guide areas that form it, have a cutout extending in the direction of the axis, which receives an adjusting shaft. The adjusting shaft is coupled with the eccentric component through a gear tooth system, the adjusting shaft being adjustable by way of an adjusting mechanism to set a desired gear ratio in the transmission.

The object of the present invention is to propose a transmission system of the species described at the beginning, with which an improved start-up process is realized at least in the same construction space.

### SUMMARY OF THE INVENTION

This problem is solved according to the invention by a transmission system for a vehicle which is coupled through a start-up element to a drive engine, an adjustable crank mechanism or the like being provided as the start-up element, in which an input shaft of the crank mechanism is coupled on the drive side with a drive shaft of the drive engine.

The crank mechanism provided as a start-up element can preferably be designed as it is known from the published patent described at the beginning. Other types of crank mechanisms can however also be utilized. Through the use of a crank mechanism it is possible in the transmission system proposed according to the invention to realize an expansion of functions with the same or less construction space, with a greater gear spread and more driving comfort being realized along with the improved start-up process.

A possible expansion of the present invention can be realized by attaching an additional sub-assembly to the crank mechanism provided as a start-up element which is capable of realizing various transmission ratios, including in particular realizing them steplessly. Preferably, this sub-assembly can be situated together with the crank mechanism functioning as a start-up element in such a way that an even greater spread of the transmission ratio is realized, and in addition the desired driving properties, such as for example pushing mode, can be retained. A continuously variable transmission can be used for example as the additional sub-assembly. Other transmission assemblies are also conceivable as the additional sub-assembly.

According to another design of the invention, it can be provided that the output shaft of the crank mechanism is coupled with a first pulley of a CVT transmission. Thus the crank mechanism can be used during the start-up process, and after the start-up process is ended a desired transmission ratio can be set steplessly by the variator of the CVT transmission.

Another version of the present invention can provide that the input shaft of the crank mechanism is coupled on the drive side with the first pulley of the CVT transmission, and the output shaft of the crank mechanism is coupled with the second pulley or with the output drive. In this way, both the start-up function and the setting of a desired transmission ratio can be accomplished as needed through the crank mechanism.

Preferably, the input shaft of the crank mechanism can be connected on the output side with the first pulley of the CVT transmission through a clutch, for example a claw clutch or the like. Thus the input shaft of the crank mechanism can be separated on the drive side from the first pulley of the CVT transmission as needed. It is also possible for a gear stage, a chain drive or the like to be provided as the connection between the input shaft and/or the output shaft of the crank mechanism on the one hand and the first pulley of the CVT transmission on the other hand, in order to make the design of the transmission system according to the invention even more flexible in regard to the transmission ratios that can be set and the power branches that can be used.

Preferably, gear stages are used in order to realize a necessary reversal of rotation direction. According to an advantageous refinement of the invention, it can be provided that the reversal of rotation direction in the transmission system proposed according to the invention is realized by having the crank mechanism include a reversible free wheel mechanism or the like. That makes it possible to save additional components in the transmission system according to the invention, such as for example a planetary turning set.

In conjunction with another design of the present invention, it can also be provided that both the input shaft and the output shaft of the crank mechanism are coupled with the first pulley of a CVT transmission. For example, the coupling can be accomplished through two gear stages, the input shaft of the crank mechanism being couplable with the first pulley through a clutch, for example a claw clutch or the like.

### BRIEF DESCRIPTION OF THE DRAWINGS

Additional advantageous designs derive from the subordinate claims and the drawings described below, which further explain the invention. The figures show the following:

FIG. 1: a schematic view of a first exemplary embodiment of a transmission system according to the invention;

FIG. 2: a schematic view of a second exemplary embodiment of the transmission system;

FIG. 3: a schematic view of a third exemplary embodiment of the transmission system; and

FIG. 4: a schematic view of a fourth exemplary embodiment of the transmission system.

### DESCRIPTION OF THE PREFERRED EMBODIMENTS

FIGS. 1 through 4 depict various exemplary embodiments of a transmission system according to the invention. Independent of the particular exemplary embodiment, a crank mechanism 1, at least as a start-up element, is connected through input shaft 2 of crank mechanism 1 to a drive shaft (not shown in further detail) of a vehicle drive, the drive shaft being indicated schematically by an arrow. In this way an improved transmission system is realized while the construction space and weight remain the same.

FIG. 1 shows a first exemplary embodiment, in which an output shaft 3 of the crank mechanism 1 provided as a start-up element is connected via a claw clutch 4 to a first pulley 5 of a CVT transmission. The transmission ratio set steplessly by the CVT transmission is coupled with the output differential 8 through a chain drive 7 by the second pulley 6 of the CVT transmission. Chain drive 7 serves at the same time to change the direction of rotation. Independent of the particular exemplary embodiment, the component used to reverse the direction of rotation can also be omitted, if the crank mechanism 1 is equipped with a reversible free wheel mechanism, whereby the change in direction of rotation is accomplished in the CVT transmission when changing between forward and reverse travel.

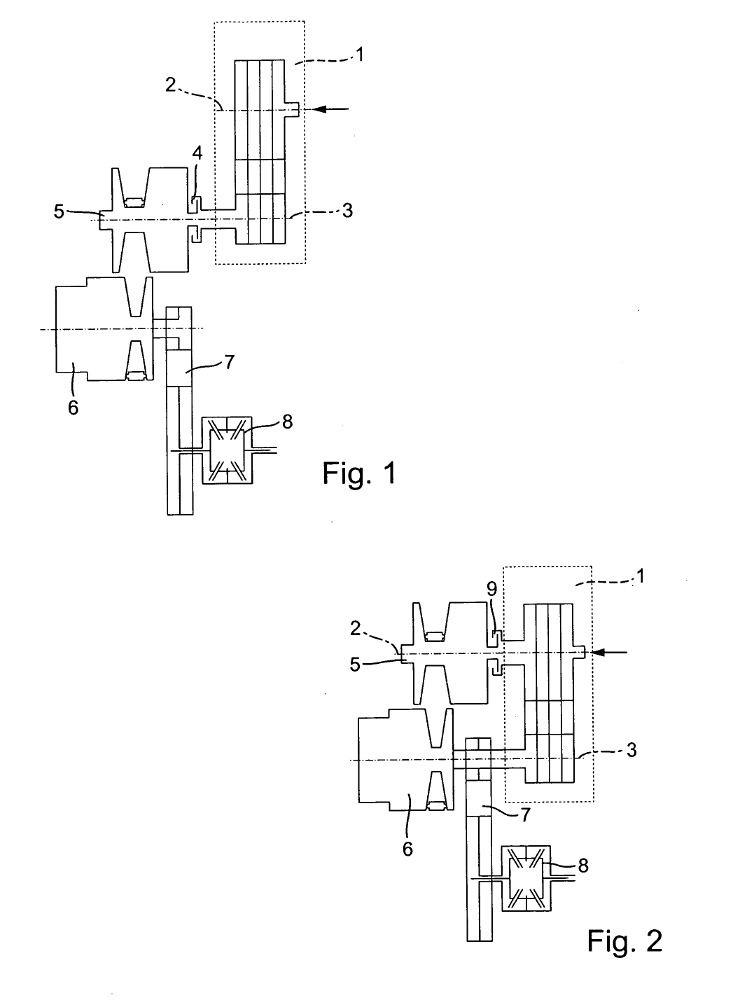

A second exemplary embodiment of the invention is depicted in FIG. 2, where—in contrast to the first exemplary embodiment—input shaft 2 of crank mechanism 1 is connected via a claw clutch 9 to first pulley 5 of the CVT transmission. In this way crank mechanism 1 can be separated from the variator branch as needed by way of the disengaged claw clutch 9. In this case crank mechanism 1 can be adjusted appropriately with the adjusting mechanism, in order to be able to set an appropriate transmission ratio. Output shaft 3 of crank mechanism 1, together with the second pulley 6 of the CVT transmission, is assigned to chain drive 7. Chain drive 7 restores the connection with the output differential 8.

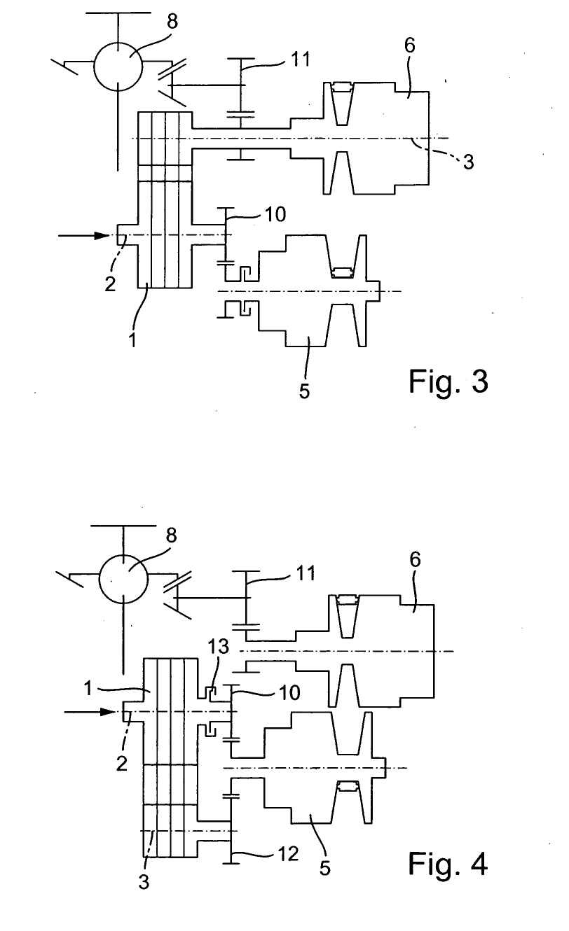

FIG. 3 shows a third exemplary embodiment of the transmission system according to the invention, in which in contrast to the second exemplary embodiment input shaft 2 of crank mechanism 1 is initially coupled via a gear stage 10 to the first pulley 5 of the CVT transmission. Gear stage 10 serves here for example as an additional reduction gear. In addition, output shaft 3 and second pulley 6 of the CVT transmission are also connected to the output differential 8 through an additional gear stage 11. Furthermore, the arrangement of the individual components of the transmission system is changed so that the crank mechanism 1 is situated on the other side compared to the second exemplary embodiment.

Finally, FIG. 4 shows a fourth exemplary embodiment, in which input shaft 2 of crank mechanism 1 is connected via a claw clutch 13 and a gear stage 10 to the first pulley 5 of the CVT transmission. Furthermore, output shaft 3 of crank mechanism is also connected through a gear stage 12 to the first pulley 5 of the CVT transmission. The second pulley 6 of the CVT transmission is connected to output differential 8 through a gear stage 11 to reverse the direction of rotation. Thus the moving-off process and a certain transmission ratio range can be realized through crank mechanism 1. Crank mechanism 1 can then be decoupled by way of claw clutch 13, so that the rest of the transmission ratio range is then realized through the CVT transmission.

What is claimed is:

1. A transmission system for a vehicle, which is coupled with a drive engine through a start-up element, characterized in that an adjustable crank mechanism is provided as the start-up element, an input shaft of the crank mechanism being coupled on the drive side with a drive shaft of the drive engine.

2. The transmission system according to claim 1, characterized in that at least one additional sub-assembly that realizes different transmission ratios is connected to the crank mechanism provided as a start-up element.

3. The transmission system according to claim 1, characterized in that the output shaft of the crank mechanism is coupled with a first pulley of a CVT transmission as an additional sub-assembly.

4. The transmission system according to claim 1, characterized in that the input shaft of the crank mechanism is coupled on the output side with the first pulley of the CVT transmission, and that the output shaft of the crank mechanism is coupled with the second pulley of the CVT transmission.

5. The transmission system according to claim 4, characterized in that the input shaft of the crank mechanism is coupled on the output side via a clutch with a first pulley of a CVT transmission.

6. The transmission system according to one of claims 4, characterized in that the output shaft of the crank mechanism and the second pulley of the CVT transmission are coupled with an output differential via a first chain drive or a gear stage.

7. The transmission system according to claim 1, characterized in that the crank mechanism includes a reversible free wheel mechanism.

8. The transmission system according to claim 1, characterized in that the input shaft and the output shaft of the crank mechanism are coupled with the first pulley of the CVT transmission.

9. The transmission system according to claim 8, characterized in that the input shaft and the output shaft of the crank mechanism are each connected via a gear stage to the first pulley, the input shaft of the crank mechanism being additionally connected to gear stage through a clutch.
